(19) United States
(12) Patent Application Publication
(10) Pub. No.: US 2012/0310849 A1
(43) Pub. Date: Dec. 6, 2012

(54) SYSTEM AND METHOD FOR VALIDATING DESIGN OF AN ELECTRONIC PRODUCT

(75) Inventor: YONG-ZHAO HUANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., New Taipei (TW)

(21) Appl. No.: 13/237,968

(22) Filed: Sep. 21, 2011

(30) Foreign Application Priority Data
Jun. 2, 2011 (CN) 201110147300.9

(51) Int. Cl. G06Q 99/00

(52) U.S. Cl. 705/317

(57) ABSTRACT

A system and method validates design of an electronic product using a computing device. The method establishes design failure data and product failure data of the electronic product in a database. When the design of the electronic product is finished, the method determines whether the design is eligible by examining design modules of the design according to the design failure data in the database. When the design is eligible, the method determines whether the validation of actual samples of the electronic device is successful by validating actual samples of the electronic product according to the product failure data in the database. If the validation of the actual samples is successful, the method acquires abnormal data of executing the actual samples, and updates failure data converted from the abnormal data into the database, if the abnormal data has been acquired.

### BACKGROUND

1. Technical Field

Embodiments of the present disclosure relate to validation systems and methods, and more particularly to a system and method for validating a design of an electronic product using a computing device.

2. Description of Related Art

Design of a complete electronic product is more and more complicated. If the electronic product is a computing system, the computing system may include a computer case, a power supply, a computer circuit board, a central processing unit, and memory, for example. Furthermore, validating the design of the electronic product is also very important. For a complicated design of the electronic product, if the validation of the complicated design is not efficient, the electronic product may not have a high reliability, and cost of the design may be increased greatly.

### BRIEF DESCRIPTION OF THE DRAWINGS

FIG. 1 is a schematic diagram of one embodiment of a computing device including a validation system.

FIG. 2 is a block diagram of function modules of the validation system included in a computing device of FIG. 1.

FIGS. 3A and 3B are schematic diagrams of one embodiment of failure data.

FIG. 4 is a flowchart of one embodiment of a method for validating a design of an electronic production using a computing device, such as, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

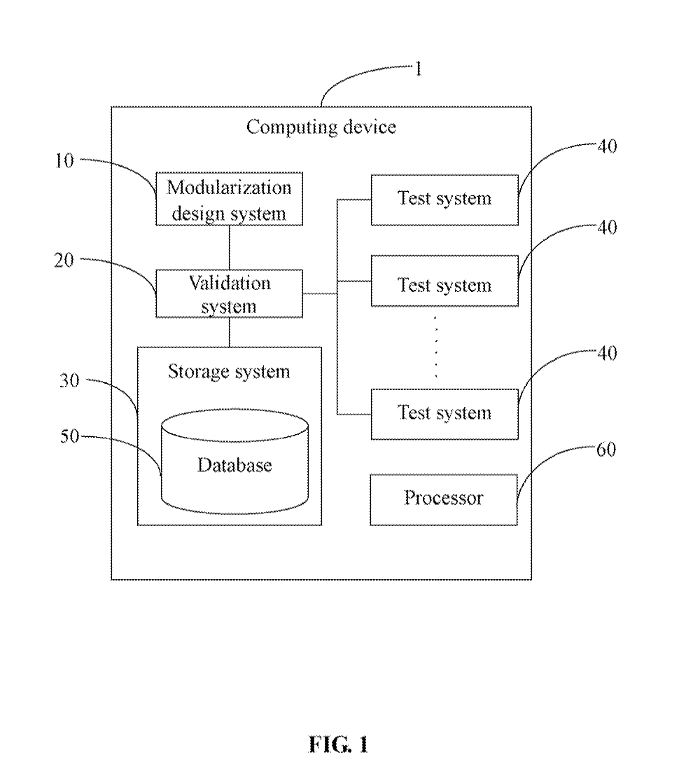

FIG. 1 is a schematic diagram of one embodiment of a computing device 1 including a validation system 20. The computing device 1 includes a modularization design system 10, a storage system 50, and a plurality of test systems 40. The modularization design system 10 can be used to devise a design of an electronic product according to a modularization design method. In one embodiment, the electronic product may be a motherboard, a computer case, or a computer system, for example. The modularization design method may include a step of defining and dividing the electronic product into a plurality of design modules according to standards or requirements, and a step of devising the electronic product according to one or more circuit diagrams of the design modules The validation system 20 may validate whether the design of the electronic product is eligible and successful.

The storage system 50 includes a database 30 for storing various failure data having a predetermined format. The database 30 may be a Failure Mode and Effects Analysis (FMEA) database. The FMEA is a procedure in product development and operations management for analysis of potential failure modes within a system for classification by the severity and likelihood of the failures. The failure data in the database 30 may include data of prediction failure modes, a prediction failure effects, severities (S), prediction failure reasons, occurrences (O), detections (D), risk priority numbers RPN (RPN=S×O×D), and suggestions, for example.

The test systems 40 perform various tests for design modules (e.g., components or circuit) of the electronic product, and actual samples of the design modules of the electronic product. The actual samples are sample products made according to the design modules. In one embodiment, the test systems 40 may be a plurality of test software to test the electronic product.

The computing device 1 further includes at least one processor 60 that executes one or more computerized codes and other applications of the computing device 1, to provide the functions of the validation system 20.

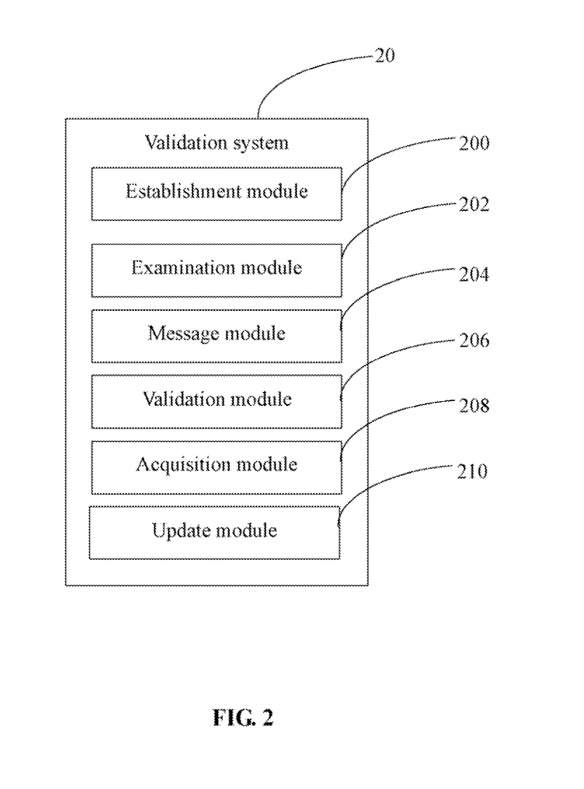

FIG. 2 is a block diagram of function modules of the validation system included in the computing device 1 of FIG. 1. In the embodiment, the validation system 20 may include an establishment module 200, an examination module 202, a message module 204, a validation module 206, an acquisition module 208, and an update module 210. The modules 200, 202, 204, 206, 208, and 210 comprise computerized codes in the form of one or more programs that are stored in the storage system 50. The computerized code includes instructions that are executed by at least one processor 60 to provide functions for the modules. Details of these operations are as follows.

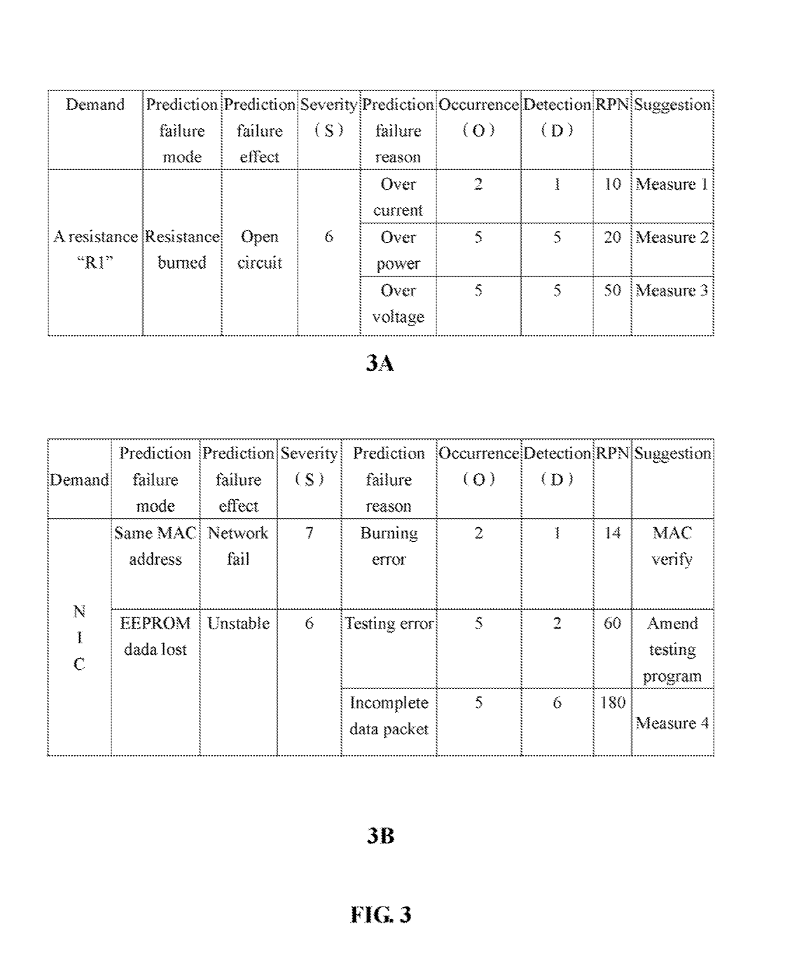

The establishment module 200 establishes design failure data and product failure data of the electronic product in the database 30. The design failure data is failure data of the design modules of the electronic product, and are established according to design standards and design experiences of the electronic product. The product failure data is failure data of the actual samples of the electronic product, and is established according to experiences of validating the actual samples of the electronic product. As shown in FIGS. 3A and 3B, the failure data include at least one prediction failure mode of design modules or the actual samples, the prediction failure effect, the severity, and at least one prediction failure reason of each prediction failure mode, the occurrence, the detection, the RPN and the suggestion of each prediction failure reason.

In one embodiment, the predetermined format of the failure data is shown like in FIG. 3A and FIG. 3B. The design modules may be components of the electronic product, such as, resistors, capacitors, and/or inductors, for example. FIG. 3A represents the failure data of a resistor “R1” in the design of the electronic product. If the electronic product is a computing system, the actual samples of the computing system may include a processor, a Network Interface Card (NIC), and a memory, for example. FIG. 3B represents failure data of the NIC.

The examination module 202 determines whether the design is eligible by examining the design modules of the design according to the design failure data stored in the database 30, after the modularization design system 10 finishes the design of the electronic product according to the requirement of the user. The detailed steps of examining the design modules of the design will be described as follows.

In one embodiment, the examination module 202 generates a design checklist (The e.g., a text file or a excel file) for each of the design modules according to the design failure data, and generates design item(s) in each design checklist according to the at least one prediction failure mode of the corresponding design module. Therefore, one design item corresponds to one prediction failure mode. In order to determine whether a test result of each design item conforms to the prediction failure mode, each of the product modules is tested through one of the test systems 40 according to the product items in each product checklist. Once at least one test result conforms to the prediction failure mode, the design of the electronic product is ineligible. If no test result conforms to the prediction failure mode, the design of the electronic product is eligible. In the embodiment, if the design of electronic product is eligible, the design may be made to be the actual samples of the electronic product.

As shown in FIG. 3A, one design module of the design of the electronic product is the resistor “R1”. The resistor “R1” includes only one prediction failure mode “resistor burned”. Therefore, the examination module 204 generates the design checklist for the design module having only one design item “the resistor “R1”. The examination module 204 tests the resistor “R1” through one of the test systems 40, to determine whether the test result conforms to the prediction failure mode “resistor burned”. If the test result conforms to the prediction failure mode “resistor burned”, the design of the electronic product is determined to be ineligible.

The message module 204 displays the prediction failure mode of the design item and design failure data corresponding to the design item, when the test result conforms to the prediction failure mode of the design item. For example, the design failure data may include the prediction failure reasons corresponding to the prediction failure mode, the risk priority number RPN and the suggestion corresponding to each of the prediction failure reasons. The users may redesign the design of the electronic product according to the above displayed data.

The validation module 206 determines whether validation of the actual samples is successful by validating the actual samples of the electronic product according to the product failure data stored in the database 30, after the design of the electronic product is made to be the actual samples. The detailed validation includes a step of generating a product checklist for each of the actual samples according to the product failure data, and a step of generating product item(s) in each product checklist according to the at least one prediction failure mode corresponding to the actual sample. Therefore, one product item corresponds to one prediction failure. In order to determine whether a test result of each product item conforms to the prediction failure mode, each of the product modules is tested through one of the test systems 40 according to the product items in each product checklist. Once at least one test result conforms to the prediction failure mode, the validation of the actual samples is determined as unsuccessful. If no test result conforms to the prediction failure mode, the validation of the actual samples is determined as successful.

As shown in FIG. 3B, the actual sample “NIC” includes two prediction failure modes “same MAC address” and “EEPROM data lost”. Therefore, the product item “MAC address” and the product item “EEPROM data” are generated in the product checklist of the actual sample “NIC”. The “MAC address” and the “EEPROM data” of the NIC are tested through one of the test systems 40, to determine whether the test result of the “MAC address” conforms to the prediction failure mode “same MAC address”, and determine whether the test result of the “EEPROM data” conforms to the prediction failure mode “EEPROM data lost”. If there is at least one test result conforms to the prediction failure mode, validation of the actual sample “NIC” is unsuccessful.

The message module 204 further displays the prediction failure mode of the product item and the design failure data corresponding to the product item, when the test result conforms to the prediction failure mode of the product item. For example, the product failure data of the product item may include the prediction failure reasons corresponding to the prediction failure mode, the RPN and the suggestion corresponding to each of the prediction failure reasons.

The acquisition module 208 acquires abnormal data of executing the actual samples of the electronic product, and determines whether the abnormal data has been acquired, after the validation of the actual samples is successful. The abnormal data may be defined as data that may occur problem when the actual samples are used or executed unsuccessfully. If the abnormal data has not been acquired, the design of the electronic product is successful. If the abnormal data has been acquired, the design of the electronic product is unsuccessful. In one embodiment, if the design of the electronic product is successful, the electronic product may be mass-produced according to the design modules and the actual samples of the electronic product.

The update module 210 updates the failure data corresponding to the abnormal data with the predetermined format into the database 30, when the abnormal data has been acquired. The failure data of the abnormal data may be the design failure data or the product failure data of the electronic product. In one embodiment, the update module 210 may delete the failure data that do not often cause failures or problems in the database 30, according to actual experiences and requirements.

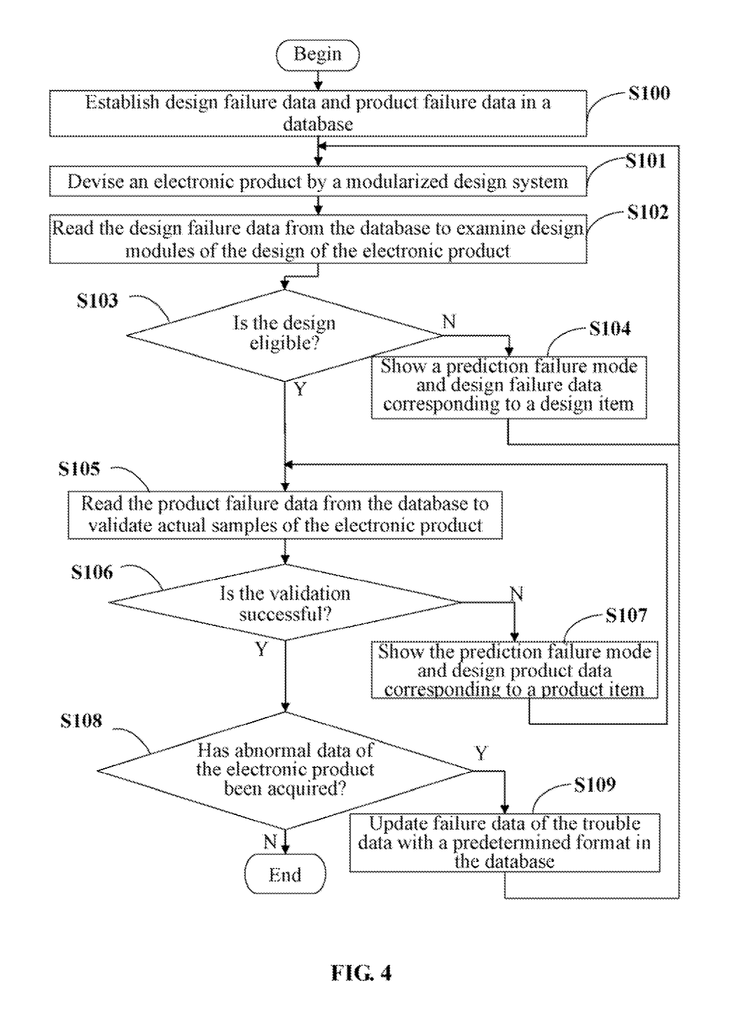

FIG. 4 is a flowchart of one embodiment of a method for validating a design of an electronic production in a computing device, such as, that of FIG. 1. Depending on the embodiment, additional blocks may be added, others deleted, and the ordering of the blocks may be changed.

In block S100, the establishment module 200 establishes design failure data and product failure data of the electronic product in the database 30. The design failure data is failure data of the design modules of the electronic product, and is established according to a design standard and design experiences of the electronic product. The product failure data is failure data of the actual samples of the electronic product, and is established according to experiences of validating the actual samples of the electronic product.

In block S101, the modularization design system 10 devises the design of the electronic product according to the requirements of the user.

If the modularization design system 10 finishes the design of the electronic product, in block S102, the examination module 202 determines whether the design is eligible by examining the design modules of design according to the design failure data stored in the database 30.

In the block S102, the examination module 202 generates a design checklist for each of the design modules according to the design failure data, and generates design item(s) in each design checklist according to the at least one prediction failure mode corresponding to the design module. In order to determine whether a test result of each design item conforms to the prediction failure mode, each of the design modules is tested through one of the test systems 40 according to the design items in each design checklists.

In block S103, the examination module 202 determines whether the design of the electronic product is ineligible. Once at least one test result conforms to the prediction failure mode, the design of the electronic product is ineligible and block S104 is implemented. If no test result conforms to the prediction failure mode, the design of the electronic product is eligible and block S105 is implemented.

In block S104, the message module 204 displays the prediction failure mode of the design item and design failure data corresponding to the design item, when the test result conforms to the prediction failure mode, and block S101 is repeated to redesign the design of the electronic product. For example, the design failure data may include the prediction failure reasons corresponding to the prediction failure mode, the risk priority number RPN and the suggestion corresponding to each of the prediction failure reasons.

In block S105, the validation module 206 validates the actual samples of the electronic product according to the product failure data stored in the database 30, after the design of the electronic product is made to be the actual samples. As mentioned above, the detailed validation include a step of generating a product checklist for each of the actual samples in the product failure data, and a step of generating product item(s) in each product checklist according to the at least one prediction failure mode of the corresponding actual sample. In order to determine whether a test result of each product item conforms to the prediction failure mode, each of the product modules is tested through one of the test systems 40 according to the product items in each product checklist.

In block S106, the validation module 206 determines whether the validation of the actual samples are successful. Once at least one test result conforms to the prediction failure mode, the validation module 206 determines that the validation of the actual samples is unsuccessful, and block S107 is implemented. If no test result conforms to the prediction failure mode, the validation module 206 determines that the validation of the actual samples is successful, and block S108 is implemented.

In block S107, the message module 204 displays the prediction failure mode of the product item and product failure data corresponding to the product item, when the test result conforms to the prediction failure mode of the design item, and the block S105 is repeated to revalidate the actual samples.

In block S108, the acquisition module 208 acquires abnormal data of executing the actual samples of the electronic product, and determines whether the abnormal data has been acquired. If the abnormal data has not been acquired, the design of the electronic product represents as being successful, and the procedure ends. If the abnormal data has been acquired, the design of the electronic product represents as being unsuccessful, and block S109 is implemented.

In block S109, the update module 210 update the failure data corresponding to the abnormal data with the predetermined format into the database 30, and block S101 is repeated to improve the design of the electronic product. The failure data of the abnormal data may be the design failure data or the product failure data of the electronic product.

It should be emphasized that the described exemplary embodiments are merely possible examples of implementations, and have been set forth for a clear understanding of the principles of the present disclosure. Many variations and modifications may be made to the described exemplary embodiments without departing substantially from the spirit and principles of the present disclosure. All such modifications and variations are intended to be included herein within the scope of this disclosure and the described inventive embodiments, and the present disclosure is protected by the following claims.

What is claimed is:

1. A computerized-method for validating design of an electronic product using a computing device, the method comprising:
establishing design failure data and product failure data of the electronic product in a database of the computing device;
determining whether the design is eligible by examining design modules of design according to the design failure data in the database;
determining whether a validation of the actual samples is successful by validating actual samples of the electronic product according to the product failure data in the database, upon the condition that the design of the electronic product is determined to be eligible;
acquiring abnormal data of executing the actual samples of the electronic product and determining whether the abnormal data has been acquired, upon the condition that validation of the actual samples is successful; and
updating failure data converted from the abnormal data with a predetermined format into the database, upon the condition that the abnormal data has been acquired.

2. The method as claimed in claim 1, wherein the design failure data is established according to a design standard and design experiences of the electronic product, and the product failure data is established according to experiences of validating the actual samples of the electronic product.

3. The method as claimed in claim 1, wherein the design failure data or the product failure data comprise at least one prediction failure mode, at least one prediction failure reasons corresponding to each of the prediction failure modes, a risk priority number and a suggestion corresponding to each of the prediction failure reasons.

4. The method as claimed in claim 3, wherein the design of the electronic product is examined by:
generating a design checklist for each of the design modules according to the design failure data, and generating at least one design item in each design checklist according to the at least one prediction failure mode of the design module;
determining whether a test result of each design item conforms to the prediction failure mode by testing each design module, according to the design items in each of the design checklists; and
determining that the design of the electronic product is ineligible, upon the condition that at least one test result conforms to the prediction failure mode; or
determining that the design of the electronic product is eligible, upon the condition that no test result conforms to the prediction failure mode.

5. The method as claimed in claim 3, wherein the actual samples of the electronic product is validated by:
generating a product checklist for each of the actual samples according to the product failure data, and generating at least one product item in each product checklist according to the at least one prediction failure mode of the actual sample;
determining whether a test result of each product item conforms to the prediction failure mode by testing each of the product modules, according to the product items in each product checklist; and
determining that the validation of the actual samples is unsuccessful upon the condition that at least one test result conforms to the prediction failure mode; or
determining that the validation of the actual samples is successful upon the condition that no test result conforms to the prediction failure mode.

6. The method as claimed in claim 3, further comprising:
displaying the prediction failure mode of the design item and the design failure data corresponding to the design item, when the test result of the design item conforms to the prediction failure mode; or
displaying the prediction failure mode of the product item and the product failure data corresponding to the product item, when the test result of the product item conforms to the prediction failure mode.

7. A non-transitory storage medium storing a set of instructions, the set of instructions capable of being executed by a processor of a computing device, cause the computing device to perform a method for validating design of an electronic production, the method comprising:
establishing design failure data and product failure data of the electronic product in a database of the computing device;
determining whether the design is eligible by examining design modules of the design according to the design failure data in the database;
determining whether a validation of the actual samples is successful by validating actual samples of the electronic product according to the product failure data in the database, upon the condition that the design of the electronic product is determined to be eligible;
acquiring abnormal data of executing the actual samples of the electronic product and determining whether the abnormal data has been acquired, upon the condition that validation of the actual samples is successful; and
updating failure data converted from the abnormal data with a predetermined format into the database, upon the condition that the abnormal data has been acquired.

8. The storage medium as claimed in claim 7, wherein the design failure data is established according to a design standard and design experiences of the electronic product, and the product failure data is established according to experiences of validating the actual samples of the electronic product.

9. The storage medium as claimed in claim 7, wherein the design failure data or the product failure data comprise at least one prediction failure mode, at least one prediction failure reasons corresponding to each of the prediction failure modes, a risk priority number and a suggestion corresponding to each of the prediction failure reasons.

10. The storage medium as claimed in claim 9, wherein the design of the electronic product is examined by:
generating a design checklist for each design module according to the design failure data, and generating at least one design item in each design checklist according to the at least one prediction failure mode of the design module;
determining whether a test result of each design item conforms to the prediction failure mode by testing each design module, according to the design items in each of the design checklists; and
determining that the design of the electronic product is ineligible, upon the condition that at least one test result conforms to the prediction failure mode; or
determining that the design of the electronic product is eligible, upon the condition that no test result conforms to the prediction failure mode.

11. The storage medium as claimed in claim 9, wherein the actual samples of the electronic product is validated by:
generating a product checklist for each of the actual samples according to the product failure data, and generating at least one product item in each product checklist according to the at least one prediction failure mode of the actual sample; and
determine whether a test result of each product item conforms to the prediction failure mode by testing each of the product modules, according to the product items in each product checklist; or
determining that the validation of the actual samples is unsuccessful upon the condition that at least one test result conforms to the prediction failure mode; or
determining that the validation of the actual samples is successful upon the condition that no test result conforms to the prediction failure mode.

12. The storage medium as claimed in claim 9, further comprising:
displaying the prediction failure mode of the design item and the design failure data corresponding to the design item, when the test result of the design item conforms to the prediction failure mode; or
displaying the prediction failure mode of the product item and the product failure data corresponding to the product item, when the test result of the product item conforms to the corresponding prediction failure mode.

13. A computing device, comprising:
a storage system;
a processor; and
one or more programs that are stored in the storage system and executed by the processor, the one or more programs comprising:
a establishment module operable to establish design failure data and product failure data of the electronic product in a database of the storage system;
a examination module operable to determine whether the design is eligible by examining design modules of the design according to the design failure data in the database;
a validation module operable to determine whether a validation of the actual samples is successful by validating actual samples of the electronic product according to the product failure data in the database, upon the condition that the design of the electronic product is determined to be eligible;
an acquisition module operable to acquire abnormal data of executing the actual samples of the electronic product and determine whether the abnormal data has been acquired, upon the condition that the validation of the actual samples is successful; and
an update module operable to update failure data converted from the abnormal data with a predetermined format into the database, upon the condition that the abnormal data has been acquired.

14. The computing device as claimed in claim 13, wherein the design failure data is established according to a design standard and design experiences of the electronic product, and the product failure data is established according to experiences of validating the actual samples of the electronic product.

15. The computing device as claimed in claim 13, wherein the design failure data or the product failure data comprise at least one prediction failure mode, at least one prediction failure reasons corresponding to each of the prediction failure modes, a risk priority number and a suggestion corresponding to each of the prediction failure reasons.

16. The computing device as claimed in claim 15, wherein the examination module examines the design of the electronic product by:
generating a design checklist for each design module according to the design failure data, and generating at least one design item in each design checklist according to the at least one prediction failure mode of the design module;
determining whether a test result of each design item conforms to the prediction failure mode by testing each design module, according to the design items in each of the design checklists; and
determining that the design of the electronic product is ineligible, upon the condition that at least one test result conforms to the prediction failure mode; or
determining that the design of the electronic product is eligible, upon the condition that no test result conforms to the prediction failure mode.

17. The computing device as claimed in claim 15, wherein the validation module validates actual samples of the electronic product by:
generating a product checklist for each of the actual samples according to the product failure data, and generating at least one product item in each product checklist according to the at least one prediction failure mode of the actual sample;
determining whether a test result of each product item conforms to the prediction failure mode by testing each of the product modules, according to the product items in each product checklist; and
determining that the validation of the actual samples is unsuccessful upon the condition that at least one test result conforms to the prediction failure mode; or
determining that the validation of the actual samples is successful upon the condition that no test result conforms to the prediction failure mode.

18. The computing device as claimed in claim 15, further comprising:
a message module operable to displaying the prediction failure mode of the design item and the design failure data corresponding to the design item, when the test result of the design item conforms to the prediction failure mode; or
displaying the prediction failure mode of the product item and the product failure data corresponding to the product item, when the test result of the product item conforms to the prediction failure mode.
